(19) United States
(12) Patent Application Publication
(10) Pub. No.: US 2020/0094738 A1
(43) Pub. Date: Mar. 26, 2020

(54) Water Level Detection During Trailer Backup

(71) Applicant: Continental Automotive Systems, Inc., Auburn Hills, MI (US)

(72) Inventors: Laurie Kay Lane, Rochester, MI (US); Brandon Herzog, Waterford, MI (US); Jeremy W. Tuggle, Shelby Township, MI (US)

(73) Assignee: Continental Automotive Systems, Inc., Auburn Hills, MI (US)

(21) Appl. No.: 16/578,015

(22) Filed: Sep. 20, 2019

Related U.S. Application Data
(60) Provisional application No. 62/733,675, filed on Sep. 20, 2018.

(51) Int. Cl. B60Q 9/00

(52) U.S. Cl. CPC B60Q 9/00; B60T 7/12; B60Y 2200/147

(57) ABSTRACT

A method for determining a water level with respect to a vehicle is provided. The method includes receiving vehicle sensor data from one or more sensors supported by the vehicle. The method also includes determining the water level based on the received sensor data. The method includes transmitting instructions to a drive system. The instructions causing vehicle brakes supported by the vehicle to engage.

### CROSS REFERENCE TO RELATED APPLICATIONS

This U.S. patent application claims priority under 35 U.S.C. § 119(e) to U.S. Provisional Application 62/733,675, filed on Sep. 20, 2018, which is hereby incorporated by reference in its entirety.

### TECHNICAL FIELD

This disclosure relates to a tow vehicle configured to attach to a trailer. The tow vehicle includes one or more sensors for determining a water level during a trailer backup.

### BACKGROUND

Trailers are usually unpowered vehicles that are pulled by a powered tow vehicle. A trailer may be a utility trailer, a popup camper, a travel trailer, livestock trailer, flatbed trailer, enclosed car hauler, and boat trailer, among others. The tow vehicle may be a car, a crossover, a truck, a van, a sports-utility-vehicle (SUV), a recreational vehicle (RV), or any other vehicle configured to attach to the trailer and pull the trailer. The trailer may be attached to a powered vehicle using a trailer hitch. A receiver hitch mounts on the tow vehicle and connects to the trailer hitch to form a connection. The trailer hitch may be a ball and socket, a fifth wheel and gooseneck, or a trailer jack. Other attachment mechanisms may also be used. In addition to the mechanical connection between the trailer and the powered vehicle, in some example, the trailer is electrically connected to the tow vehicle. As such, the electrical connection allows the trailer to take the feed from the powered vehicle's rear light circuit, allowing the trailer to have taillights, turn signals, and brake lights that are in sync with the powered vehicle's lights.

When towing a boat, a driver may put the boat supported by the trailer in the water to release the boat or the driver may take out the boat from the water. Usually, releasing or attaching the boat is done at an incline. In some examples, the driver fails to place the tow vehicle in park or to secure a park brake during the releasing or attaching process. This may lead to a situation where the tow vehicle is held still while the driver is inside, but once the driver exits the tow vehicle and a weight shifts on the trailer, the vehicle may roll in the backward direction causing injury to the driver, or loss of the vehicle and the trailer into the water. Therefore, it is desirable to have a tow vehicle having a system that overcomes these challenges and prevents the tow vehicle and or the vehicle-trailer system to slow roll on an incline when the driver is not in the tow vehicle.

### SUMMARY

One aspect of the disclosure provides a method of determining a water level with respect to a vehicle. The method includes receiving, at data processing hardware (e.g., the vehicle controller having the hardware processor), vehicle sensor system data from one or more sensors supported by the vehicle. The method includes determining, at the data processing hardware, the water level based on the received sensor system data. In addition, the method includes transmitting, from the data processing hardware to a drive system in communication with the data processing hardware, instructions to engage vehicle brakes supported by the vehicle.

Implementations of the disclosure may include one or more of the following optional features. In some implementations, the vehicle is attached to a trailer by way of a hitch point and by way of an electrical connection (not shown). The electrical connection allows the trailer to take the feed from the powered vehicle's rear light circuit, allowing the trailer to have taillights, turn signals, and brake lights that are in sync with the powered vehicle's lights. In addition, the electrical connection allows the trailer to transmit to the vehicle trailer sensor data relating to the trailer. In this case, the method 300 includes receiving trailer sensor data from one or more sensors supported by the trailer. The trailer sensor data including data relating to the trailer. The method also includes determining the water level based on the received sensor system data and the trailer sensor data. The method includes transmitting instructions to the drive system 110, where the instructions cause the vehicle brakes and trailer brakes (not shown) to engage.

In some implementations, the method includes transmitting display instruction to a user interface in communication with the data processing hardware. The display instructions cause the user interface to inform a driver of the vehicle of the water level. The user interface may include a display that displays an indication of the water level. In some examples, the one or more sensors include at least one of a level float, a camera, a radar or lidar.

Another aspect of the disclosure provides a system for determining a water level with respect to a vehicle. The system includes data processing hardware and memory hardware in communication with the data processing hardware. The memory hardware stores instructions that when executed on the data processing hardware cause the data processing hardware to perform operations that include the method described above.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1A is a top view of an exemplary tow vehicle hitched to a trailer.

FIG. 1B is a top view of the exemplary tow vehicle and the trailer shown in FIG. 1A, where the trailer is at an angle with respect to the tow vehicle.

FIGS. 1C and 1D are side views of the exemplary tow vehicle and the trailer shown in FIG. 1A, where the vehicle and trailer are backing up at an incline.

FIG. 2 is a schematic view of an exemplary tow vehicle having a water detection system.

FIG. 3 is a schematic view of an exemplary arrangement of operations for engaging vehicle brakes when water is detected.

Like reference symbols in the various drawings indicate like elements.

### DETAILED DESCRIPTION

A tow vehicle, such as, but not limited to a car, a crossover, a truck, a van, a sports-utility-vehicle (SUV), and a recreational vehicle (RV) may be configured to tow a trailer. The tow vehicle connects to the trailer by way of a trailer hitch. In some examples, the tow vehicle is attached to a boat and a driver of the tow vehicle may back up along an incline towards the water to release or attach the boat. In this case, it is desirable for the tow vehicle to include a water detection system capable of detecting when a vehicle is entering the water and determining when a predefined vehicle point (e.g., the vehicle bumper) has reached the water or is submerged in the water. Once the water detection system detects water at the predefined vehicle point and, in some examples, that the driver is not in the vehicle, then the water detection system instructs a drive system of the vehicle to apply the brakes to hold the vehicle at standstill until the driver can reenter the car. In other words, the water detection system instructs the drive system of the vehicle to apply failsafe braking to hold the vehicle at standstill until the driver can reenter the tow vehicle and manually disengage the park brake and/or failsafe braking.

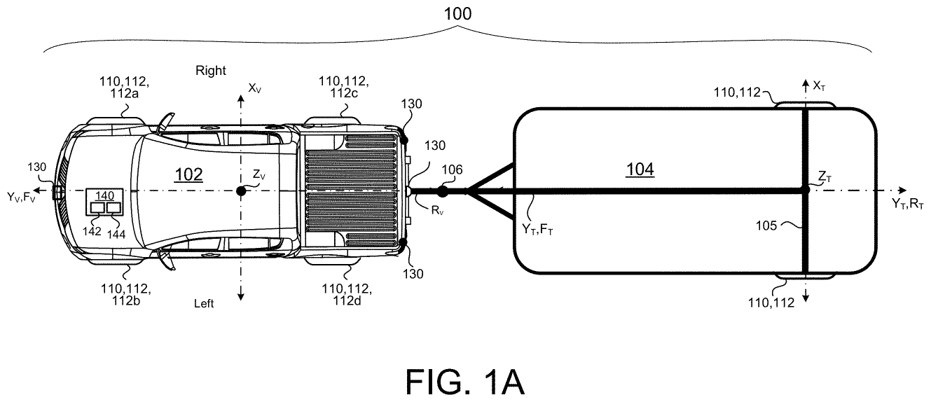

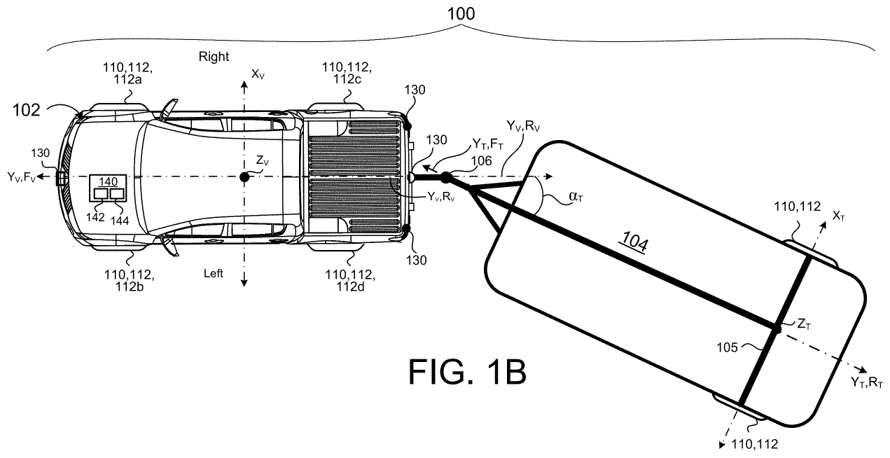

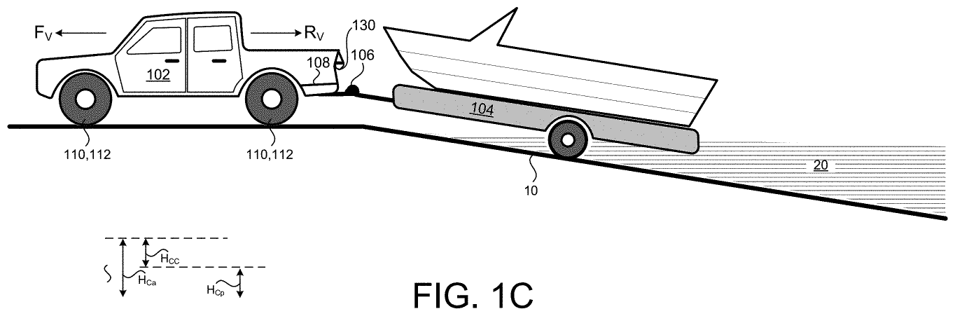

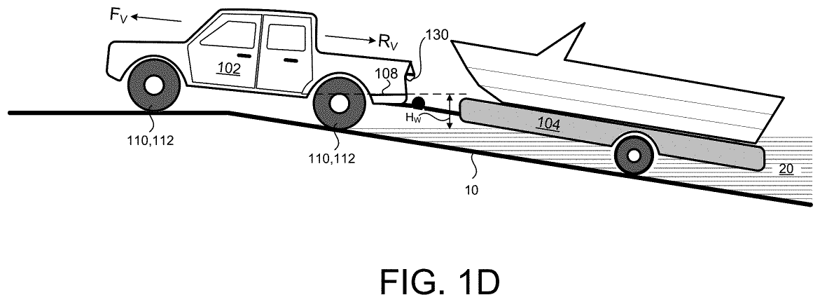

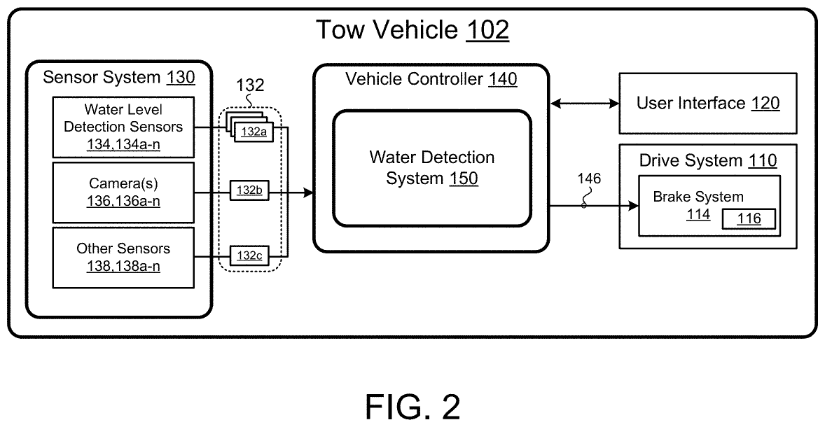

Referring to FIGS. 1A-2, in some implementations, a vehicle-trailer system 100 includes a tow vehicle 102 hitched to a trailer 104 by way of a hitch 106. The tow vehicle 102 includes a drive system 110 associated with the tow vehicle 102 that maneuvers the tow vehicle 102 and thus the vehicle-trailer system 100 across a road surface 10 based on drive maneuvers or commands having x, y, and z components, for example. As shown, the drive system 110 includes a front right wheel 112, 112a, a front left wheel 112, 112b, a rear right wheel 112, 112c, and a rear left wheel 112, 112d. In addition, the drive system 110 may include wheels (not shown) associated with the trailer 104. The drive system 110 may include other wheel configurations as well. The drive system 110 includes other components (not shown) that are in communication with and connected to the wheels 112 that allow the tow vehicle 102 to move, thus moving the trailer 104 as well. The drive system 110 may also include a brake system 114 that includes brakes 116 associated with each wheel 112, 112a-d, where each brake 116 is associated with a wheel 112a-d and is configured to slow down or stop the wheel 112a-n from rotating. In some examples, the brake system 114 is connected to one or more brakes 116 supported by the trailer 104. The drive system 110 may also include an acceleration system that is configured to adjust a speed of the tow vehicle 102 and thus the vehicle-trailer system 100, and a steering system that is configured to adjust a direction of the tow vehicle 102 and thus the vehicle-trailer system 100. The vehicle-trailer system 100 may include other systems as well.

The tow vehicle 102 may move across the road surface 10 by various combinations of movements relative to three mutually perpendicular axes defined by the tow vehicle 102: a transverse axis X_{V}, a fore-aft axis Y_{V}, and a central vertical axis Z_{V}. The transverse axis X_{V}, extends between a right side R and a left side of the tow vehicle 102. A forward drive direction along the fore-aft axis Y_{V} is designated as F_{V}, also referred to as a forward motion. In addition, an aft or rearward drive direction along the fore-aft direction Y_{V} is designated as R_{V}, also referred to as rearward motion. In some examples, the tow vehicle 102 includes a suspension system (not shown), which when adjusted causes the tow vehicle 102 to tilt about the X_{V} axis and or the Y_{V} axis, or move along the central vertical axis Z_{V}. As the tow vehicle 102 moves, the trailer 104 follows along a path of the tow vehicle 102. Therefore, when the tow vehicle 102 makes a turn as it moves in the forward direction F_{V}, then the trailer 104 follows along.

Moreover, the trailer 104 follows the tow vehicle 102 across the road surface 10 by various combinations of movements relative to three mutually perpendicular axes defined by the trailer 104: a trailer transverse axis X_{T}, a trailer fore-aft axis Y_{T}, and a trailer central vertical axis Z_{T}. The trailer transverse axis X_{T}, extends between a right side R and a left side of the trailer 104, for example, along the trailer axle 105. A forward drive direction along the trailer fore-aft axis Y_{T} is designated as F_{T}, also referred to as a forward motion. In addition, a trailer aft or rearward drive direction along the fore-aft direction Y_{T} is designated as R_{T}, also referred to as rearward motion. Therefore, movement of the vehicle-trailer system 100 includes movement of the tow vehicle 102 along its transverse axis X_{V}, fore-aft axis Y_{V}, and central vertical axis Z_{V}, and movement of the trailer 104 along its trailer transverse axis X_{T}, trailer fore-aft axis Y_{T}, and trailer central vertical axis Z_{T}. Therefore, when the tow vehicle 102 makes a turn as it moves in the forward direction F_{V}, then the trailer 104 follows along. While turning, the tow vehicle 102 and the trailer 104 form a trailer angle α_{T} being an angle between the vehicle fore-aft axis Y_{V} and the trailer fore-aft axis Y_{T}.

The tow vehicle 102 may include a user interface 120, such as a display. The user interface 120 is configured to display information to the driver. In some examples, the user interface 120 is configured to receive one or more user commands from the driver via one or more input mechanisms or a touch screen display and/or displays one or more notifications to the driver. In some examples, the user interface 120 is a touch screen display. In other examples, the user interface 120 is not a touchscreen and the driver may use an input device, such as, but not limited to, a rotary knob or a mouse to make a selection. The user interface 120 may alert the driver of the water level.

In some implementations, the tow vehicle 102 includes a sensor system 130 to provide sensor system data 132 that may be used to determine one or more measurements associated with an environment of the tow vehicle 102, the trailer 104, and/or objects surrounding the tow vehicle 102. In some examples, the tow vehicle 102 may be autonomous or semi-autonomous, therefore, the sensor system 130 provides reliable and robust autonomous driving. The sensor system 130 may include different types of sensors that may be used separately or with one another to create a perception of the tow vehicle's environment or a portion thereof that is used by the vehicle-trailer system 100 to determine measurements and/or identify object(s) in its environment and/or in some examples autonomously drive and make intelligent decisions based on objects and obstacles detected by the sensor system 130. In some examples, the sensor system 130 is supported by the rear portion of the tow vehicle 102 and provides sensor system data 132 associated with object(s) and the trailer 104 positioned behind the tow vehicle 102. In some examples, the sensor system 130 provides sensor system data 132 that includes detection and measurement of water level with respect to the tow vehicle 102. The tow vehicle 102 may support the sensor system 130; while in other examples, the sensor system 130 is supported by the tow vehicle 102 and the trailer 104. The sensor system 130 may include sensor(s) 134, 136, 138 positioned on the rear vehicle bumper 108 for rear water detection and/or on the front bumper (not shown) for front water detection. In some examples, the sensor system 130 may also include sensor(s) 134, 136, 138 positioned on a rear portion of the trailer 104 for trailer rear water detection.

In some implementations, the sensor system 130 includes one or more water level detection sensors 134, 134a-n, such as a level sensor configured to detect the water level 132a of water 20 with respect to a location of the tow vehicle 102 (e.g., the vehicle bumper 108). The water level detection sensors 134, 134a-n may be a float switch, which is a type of level sensor that is configured to detect the level of water with respect to the tow vehicle 102. The water level detection sensors 134, 134a-n determine water level data 132a associated with the water level with respect to the predefined location of the tow vehicle 102.

In some implementations, the sensor system 130 includes one or more imaging devices 136, 136a-n (such as camera(s)). The one or more cameras 136, 136a-n capture images of an environment of the tow vehicle 102. In some examples, a rear camera 126 is positioned on a rear portion of the tow vehicle 102 and is configures to capture images 132b of the ground 10 such that when the tow vehicle 102 is approaching a body of water 20, the rear camera 126 captures images of the water 20.

In some implementations, the sensor system 130 includes other sensors 138, 138a-n such as, but not limited to, radar, sonar, LIDAR (Light Detection and Ranging, which can entail optical remote sensing that measures properties of scattered light to find range and/or other information of a distant target), LADAR (Laser Detection and Ranging), ultrasonic sensors, etc. The other sensors 138, 138a-n may be positioned on a rear portion of the tow vehicle 102 such that when the tow vehicle 102 is approaching the water 20, the other rear sensors 138 capture sensor data 132c detecting the water 20 or water level with respect to the tow vehicle 102.

The sensor system 130 provides sensor system data 132 that includes at least one of water level data 122a captured by the water level detection sensor(s) 134, camera image(s) 132b captured by the camera(s) 136, and sensor data 132c captured by the other sensors 138. Therefore, the sensor system 130 is especially useful for receiving information of the environment or portion of the environment of the vehicle and for increasing safety in the vehicle-trailer system 100 which may operate by the driver or under semi-autonomous or autonomous conditions.

The drive system 110, the user interface 120, and the sensor system 130 are in communication with a vehicle controller 140 that includes a computing device (or data processing hardware) 142 (e.g., central processing unit having one or more computing processors) in communication with non-transitory memory or hardware memory 144 (e.g., a hard disk, flash memory, random-access memory) capable of storing instructions executable on the computing processor(s)). In some example, the non-transitory memory 144 stores instructions that when executed on the computing device 142 cause the vehicle controller 140 to provide a signal or command 146 to stop the tow vehicle 102 when the sensor system 130 detects water 20. As shown, the vehicle controller 140 is supported by the tow vehicle 102; however, the vehicle controller 140 may be separate from the tow vehicle 102 and in communication with the tow vehicle 102 via a network (not shown).

The vehicle controller 140 executes a water detection system 150 that receives sensor system data 132 from the water level detection sensor(s) 134, camera(s) 136, and/or other sensors 138. The water detection system 150 processes the sensor system data 132 and based on the processed sensor system data 132, the water detection system 150 determines if the vehicle controller 140 (or the water detection system 150) should send instructions to the drive system 110 (or the brake system 114) causing the brakes 116 to engage and preventing the tow vehicle 102 from moving in the forward or reverse directions. The water detection system 150 analyses the received sensor system data 132 and determines a water level H_{W} with respect to the vehicle and determines either the distance H_{W} to the water level or an indication that the vehicle 102 has started to enter the water 20 by way of the user interface 120. This could be for forward or reverse direction.

In some implementations, the water detection system 150 determines a level of the water 20 based on the received sensor system data 132. For examples, when the water detection system 150 determines that the water 20 has reached a top portion of one or both of the vehicle rear tires, then the water detection system 150 instructs the drive system 110 or the brake system 114 to engage the brakes 116 to stop the tow vehicle 102 from continued reverse roll.

The water detection system 150 may determine the water level and water height H_{W} by using one or all the available sensors 134, 136, 138 to alert the driver of an oncoming body of water 20. Therefore, the water detection system 150 increases the driver safety relating to vehicle-trailer system 100 when attaching or releasing a boat on an incline to the water 20. For example, the water detection system 150 instructs the drive system 110 or the brake system 114 to automatically engage the vehicle brakes and the trailer brakes (if the tow vehicle 102 is connected to the trailer 104) upon detection of water 20 being at a certain level with respect to the tow vehicle 102.

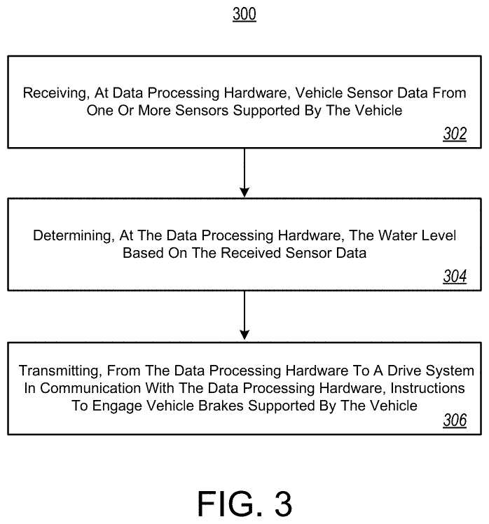

FIG. 3 provides an examples arrangement of operations for a method 300 of determining a water level with respect to a vehicle 102, using the system described in FIGS. 1A-2. At block 302, the method 300 includes receiving, at data processing hardware (e.g., the vehicle controller 140 having the hardware processor 142), vehicle sensor system data 132 from one or more sensors 130 supported by the vehicle 102. At block 304, the method 300 includes determining, at the data processing hardware 142, the water level H_{W} based on the received sensor system data 132. At block 306, the method 300 includes transmitting, from the data processing hardware 142 to a drive system 110 in communication with the data processing hardware 142, instructions 146 to engage vehicle brakes 116 supported by the vehicle 102.

In some implementations, the vehicle is attached to a trailer 104 by way of a hitch point 106 and by way of an electrical connection (not shown). The electrical connection allows the trailer 104 to take the feed from the powered vehicle's rear light circuit, allowing the trailer to have taillights, turn signals, and brake lights that are in sync with the powered vehicle's lights. In addition, the electrical connection allows the trailer 104 to transmit to the vehicle trailer sensor data relating to the trailer 104. In this case, the method 300 includes receiving trailer sensor data from one or more sensors supported by the trailer. The trailer sensor data including data relating to the trailer 104. The method 300 also includes determining the water level H_{W} based on the received sensor system data 132 and the trailer sensor data. The method 300 includes transmitting instructions 146 to the drive system 110, where the instructions 146 cause the vehicle brakes 116 and trailer brakes (not shown) to engage.

In some implementations, the method includes transmitting display instruction to a user interface 120 in communication with the data processing hardware 142. The display instructions cause the user interface 120 to inform a driver of the vehicle of the water level H_{W}. The user interface 120 may include a display that displays an indication of the water level H_{W}.

In some examples, the one or more sensors 134, 136, 138 include at least one of a level float 134, a camera 136, a radar 138 or lidar 138.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Implementations of the subject matter and the functional operations described in this specification can be implemented in digital electronic circuitry, or in computer software, firmware, or hardware, including the structures disclosed in this specification and their structural equivalents, or in combinations of one or more of them. Moreover, subject matter described in this specification can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The terms “data processing apparatus”, “computing device” and “computing processor” encompass all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

Similarly, while operations are depicted in the drawings in a particular order, this should not be understood as requiring that such operations be performed in the particular order shown or in sequential order, or that all illustrated operations be performed, to achieve desirable results. In certain circumstances, multi-tasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

A number of implementations have been described. Nevertheless, it will be understood that various modifications may be made without departing from the spirit and scope of the disclosure. Accordingly, other implementations are within the scope of the following claims.

What is claimed is:

1. A method for determining a water level with respect to a vehicle, the method comprising:
receiving, at data processing hardware, vehicle sensor system data from one or more sensors supported by the vehicle;
determining, at the data processing hardware, the water level based on the received sensor system data; and
transmitting, from the data processing hardware to a drive system in communication with the data processing hardware, instructions to engage vehicle brakes supported by the vehicle.

2. The method of claim 1, wherein the vehicle is attached to a trailer.

3. The method of claim 2, further comprising:
receiving trailer sensor data from one or more sensors supported by the vehicle;
determining the water level based on the received trailer sensor data; and
transmitting instructions to the drive system, the instructions causing the vehicle brakes and trailer brakes of the trailer to engage.

4. The method of claim 1, wherein the one or more sensors include a level float.

5. The method of claim 1, wherein the one or more sensors include a camera.

6. The method of claim 1, wherein the one or more sensors include a radar or lidar.

7. The method of claim 1, further comprising:
transmitting instruction to a user interface in communication with the data processing hardware, the instructions causing the user interface to inform a driver of the vehicle of the water level.

8. The method of claim 7, wherein the user interface is a display configured to display the water level.

9. A system for determining a water level with respect to a vehicle, the system comprising:
data processing hardware; and
memory hardware in communication with the data processing hardware, the memory hardware storing instructions that when executed on the data processing hardware cause the data processing hardware to perform operations comprising:
receiving vehicle sensor system data from one or more sensors supported by the vehicle;
determining the water level based on the received sensor system data; and
transmitting instructions to a drive system to engage vehicle brakes supported by the vehicle.

10. The system of claim 9, wherein the vehicle is attached to a trailer.

11. The system of claim 10, wherein the operations further comprise:
receiving trailer sensor data from one or more sensors supported by the vehicle;
determining the water level based on the received trailer sensor data; and
transmitting instructions to the drive system, the instructions causing the vehicle brakes and trailer brakes of the trailer to engage.

12. The system of claim 9, wherein the one or more sensors include a level float.

13. The system of claim 9, wherein the one or more sensors include a camera.

14. The system of claim 9, wherein the one or more sensors include a radar or lidar.

15. The system of claim 9, wherein the operations further comprise:
transmitting instruction to a user interface in communication with the data processing hardware, the instructions causing the user interface to inform a driver of the vehicle of the water level.

16. The system of claim 15, wherein the user interface is a display configured to display the water level.
